(19) United States
(12) Patent Application Publication
(10) Pub. No.: US 2006/0038698 A1
(43) Pub. Date: Feb. 23, 2006

(54) Multi-purpose remote control input device

(76) Inventor: Jim T. Chen, Kaohsiung City (TW)

Correspondence Address: LEONG C LEI, PMB # 1008, 1867 YGNACIO VALLEY ROAD, WALNUT CREEK, CA, 94598, US

(21) Appl. No.: 10/921,099

(22) Filed: Aug. 19, 2004

(51) Int. Cl. H04L 17/02

(52) U.S. Cl. 340/825.69; 341/176

(57) ABSTRACT

A multi-purpose remote control input device comprised of a transmitter and a receiver; the receiver in a form of adapter being installed to the controlled system including a PC or PS2 game machine; the transmitter including PS2 DVD/TV/VCR control interface adapted with functional keys corresponding to PS2 DVD, TV, VCR hosts; keyboard/mouse/joystick input interface adapted with input keys corresponding to computer keyboard and mouse keys to control TV, PS2 game machine, VCR and as the wireless keyboard and mouse for a PC.

### BACKGROUND OF THE INVENTION

(a) Technical Field of the Invention

The present invention is related to a multi-purpose remote control input device, and more particularly, to a multi-purpose remote controller for TV, PS2 game machine, and videocassette recorder/player, or as wireless keyboard and mouse for a PC.

(b) Description of the Prior Art

As electronic technology advances, remote controllers are available for making adjustments of a comprehensive range of electric appliances without approaching them. When many more types of electric appliances are introduced and each unit is supplied with its dedicated remote controller. Consequently, the user is caught in awkward situation to fumble among a bunch of remote controllers to find the right one. Later, multi-purpose remote controller is available to control several electronic systems, namely, TV set, VCR, air conditioner, etc. However, the prerequisite is that those electronic systems must be provided with a receiver to facilitate receiving the commands from the remote controller. Saving such receiver as found with electronic products including game machines and computers, such multi-purpose remote controller is useless. Today, the fact is that too many users have game machines and PC at the same time. The shame is that they have to be stuck with cabled joystick, keyboard and mouse due to the wireless equipment is too expensive to own. They are not satisfied yet they have to live with it. Therefore, there should be an affordable solution for those users.

### SUMMARY OF THE INVENTION

The primary purpose of the present invention is to provide a multi-purpose remote control input device essentially comprised of a transmitter and a receiver. The receiver depending on the type of adapter is installed to a controlled system including a PC or PS2 game machine. The transmitter includes PS2 DVD/TV/VCR control interface adapted with functional keys corresponding to PS2 DVD, TV, VCR hosts; and keyboard/mouse/joystick input interface adapted with input keys corresponding to computer keyboard, mouse keys, and input keys and touch screen of PS2 joystick. Upon receiving control signals from the transmitter, the controlled system executes the command accordingly.

Another purpose of the present invention is to provide a multi-purpose remote control input device that gives the basic functions as a multi-purpose remote controller of the prior art and functions also as a remote control input device for a PC and PS2 game machine through easy operation and control.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

Figs. 1A and 1B are schematic views showing the operation of a preferred embodiment of the present invention.

FIG. 2 is a block chart showing the interaction among essential structures of a transmitter of the preferred embodiment of the present invention.

FIG. 3 is a block chart showing the interaction among essential structures of a receiver of the preferred embodiment of the present invention.

FIG. 4 is a schematic view showing the appearance of the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

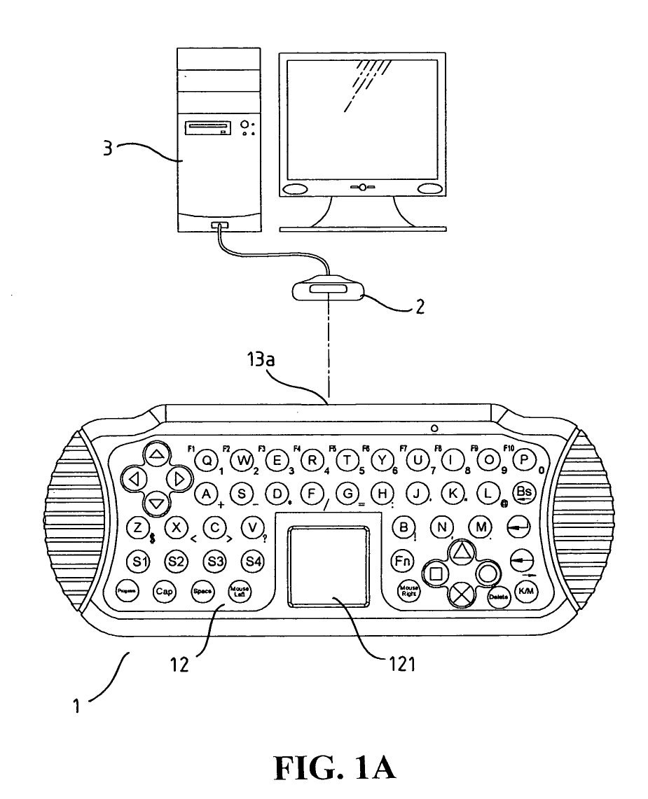

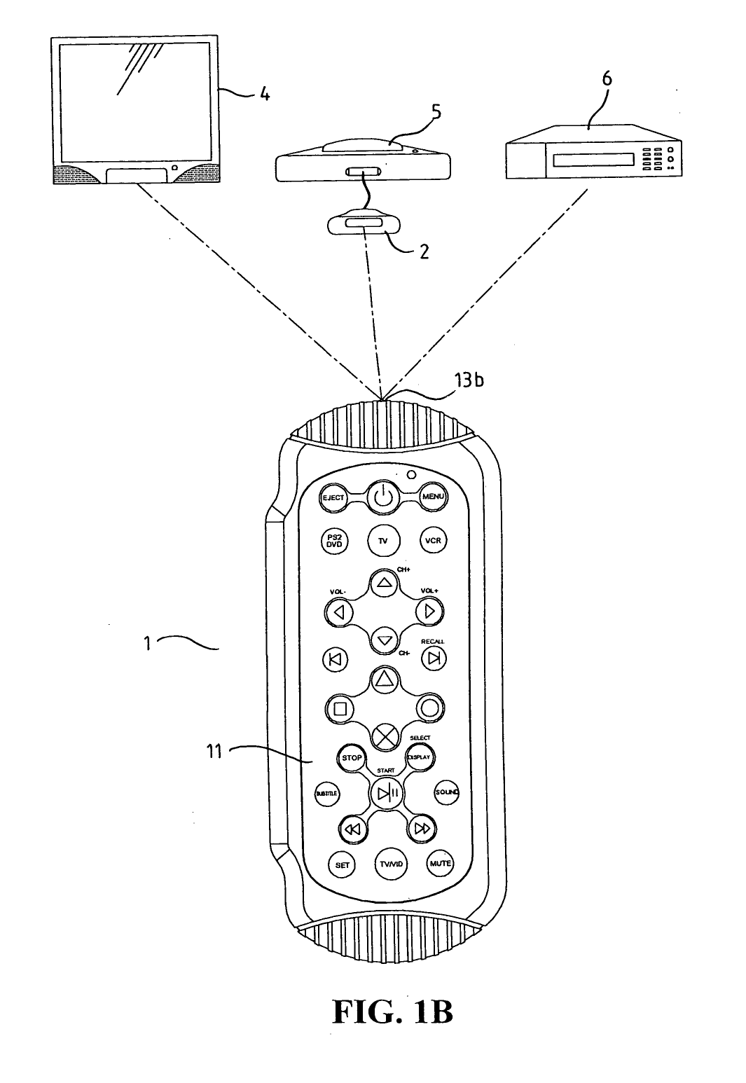

Referring to Figs. 1A and 1B for schematic views showing the operation of a preferred embodiment of the present invention, the preferred embodiment is essentially comprised of a transmitter (1) and a receiver (2). Wherein, the transmitter (1) includes a PS2 DVD/TV/VCR control interface (11), and a keyboard/mouse/joystick input interface (12). The PS2 DVD/TV/VCR control interface (11) is provided with functional keys corresponding to the operation of the hosts respectively of the PS2 DVD, TV, and VCR while the keyboard/mouse/joystick input interface (12) is provided with input keys and touch screen (121) corresponding to the computer keyboard, mouse keys and PS2 joystick. Each of both interfaces is adapted with independent IR signal emitting port (13a, 13b). The receiver (2) is a member for receiving the control signals sent by the transmitter (1). Depending on the controlled system, an adapter to connect the receiver (2) to the computer may be of a USB port. In case of the PS2 game machine, the adapter to connect the receiver to the PS2 game machine is the same as that used for the external joystick. The adapter after the link serves as the signal linkage between the computer, PS2 game machine and the transmitter (1) to facilitate the use of the transmitter in executing operation control and input.

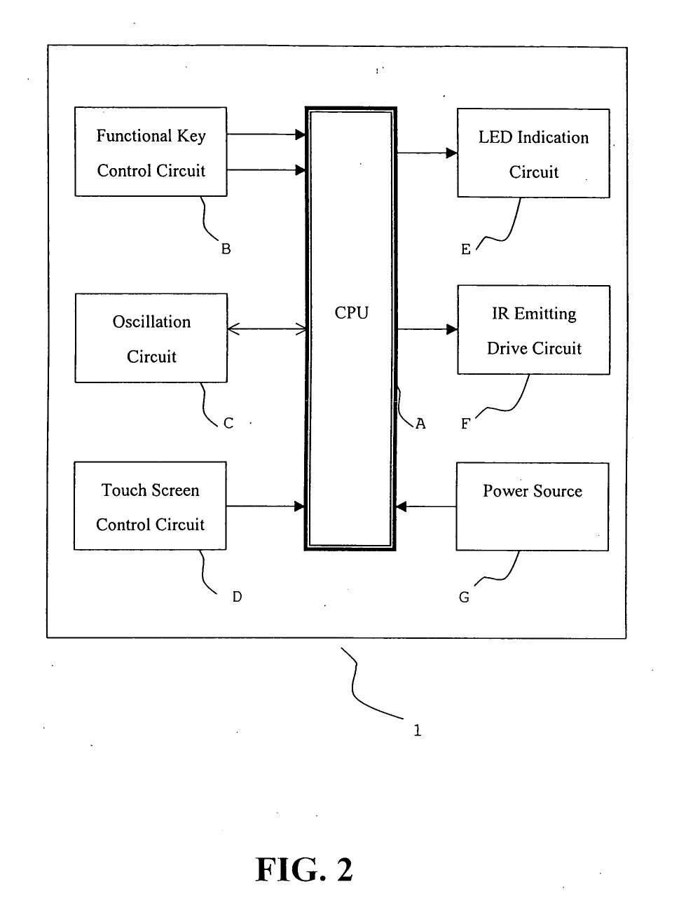

Now referring to FIG. 2 for a block chart showing the interaction among the primary structures of the transmitter (1), the transmitter (1) includes a CPU (A), a functional key control circuit (B), an oscillation circuit (C), a touch screen control circuit (D), an LED indication circuit (E), an IR emitting drive circuit (F) and a power source (G). When a key is pushed or the touch screen (121) is touched on the PS2 DVD/TV/VCR control interface (11) and the keyboard/mouse/joystick input interface (12), the functional key control circuit (B) and the touch screen control circuit (D) produce a control signal through the oscillation circuit (C) after the signal is encoded and translated by the CPU (A). The IR emitting drive circuit (F) then sends the signal while the LED indication circuit (E) will cause the corresponding light LED indicator to be on or off depending on the location of the key depressed.

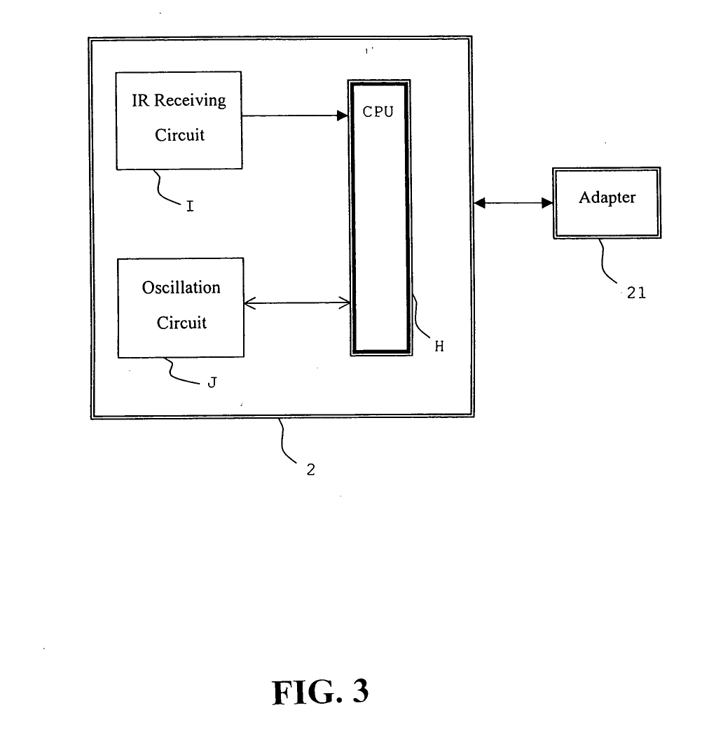

As illustrated in FIG. 3 for a block chart showing the interaction among the primary structures of the receiver (2), the receiver (2) includes a CPU (H), an IR receiving circuit (1), an oscillation circuit (J) and an adapter (21). Wherein, the adapter (21) may be of a USB port or one that is identical to that used for the externally connected joystick. Depending on the type of the adapter, the receiver (2) is installed to the controlled system of a computer or a PS2 game machine. When the IR receiving circuit (I) picks up the control signals sent from the transmitter (1), the CPU (H) and the oscillation circuit (J) will translate it into a command that is acceptable to the controlled system followed with the action according to the command.

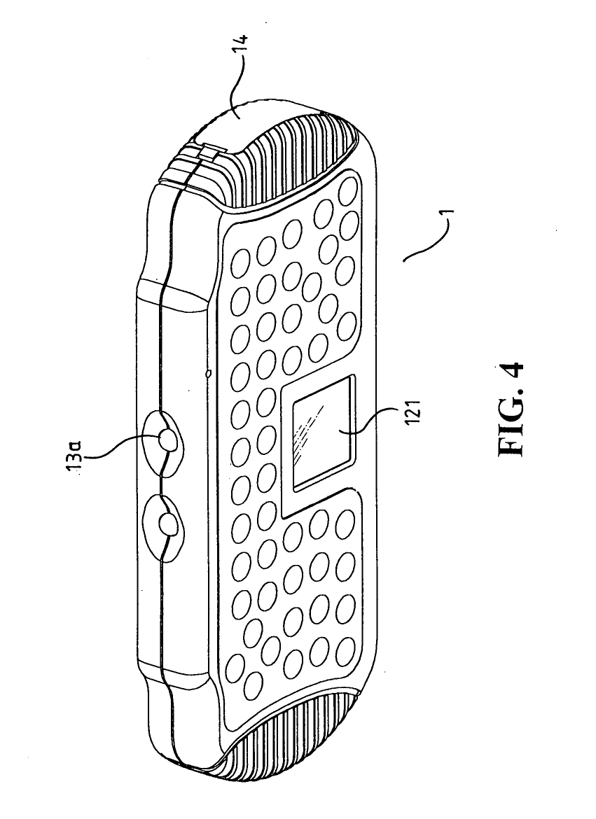

FIG. 4 shows an appearance of the transmitter (2). Wherein, the layout of the keys shall be such to facilitate the operation by fingers of the user and meet the operation habits of the majority of the users.

When compared to a remote controller of the prior art, the present invention gives the following advantages:
1. Additional to the basic functions expected from the multi-purpose remote controller of the prior art, the present invention by simply operation achieves the control of a computer and PS2 game machine for remote control input.
2. The present invention significantly lower the pricing of wireless remote controller for the computer and game machine to make it affordable by most of the users in achieving the purpose of enjoying the benefits from technology.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-purpose remote control input device comprised of a transmitter and a receiver; the transmitter including a PS2 /DVD/VCR control interface and a keyboard/mouse/joystick input interface; the PS2 DVD/TV/VCR control interface being provided with functional keys corresponding to the operation keys on the PS2 DVD, TV and VCR; the keyboard/mouse/joystick input interface being provided with input keys and touch screen corresponding computer keyboard, mouse keys and PS2 joystick; each of both interfaces being provided with independent IR signal emitting port; and the receiver being related to a member capable of receiving the control signal emitted by the transmitter.

2. The multi-purpose remote control input device of claim 1, wherein, the transmitter includes a CPU, a functional key control circuit, an oscillation circuit, a touch screen control circuit, an LED indication circuit, an IR emitting driver circuit and a power source; the functional key control circuit and the touch screen control circuit producing a signal in responding to a key depressed or a touch screen touched on the PS2 DVD/TV/VCR control interface and the key/mouse/joystick input interface; the signal being encoded and translated by the CPU encoding and translating; the oscillation circuit producing a control signal; and the control signal being sent by the IR emitting driver circuit; and the LED indication circuit instructing LED lamps of various light colors to be on or off depending on the location of key depressed.

3. The multi-purpose remote control input device of claim 1, wherein, the receiver includes a CPU, an IR receiving circuit, an oscillation circuit and an adapter; the adapter being of a USB port or the same as that used for the externally connected joystick; the receiver being installed to a controlled system of a computer or game machine; the CPU and the oscillation circuit translating control signals received by the IR receiving circuit to command acceptable to the controlled system and responding accordingly.
